(19) United States
(12) Patent Application Publication
(10) Pub. No.: US 2015/0327708 A1
(43) Pub. Date: Nov. 19, 2015

(54) COOKWARE

(71) Applicant: JUNG WON PARK, Busan (KR)

(72) Inventor: JUNG WON PARK, Busan (KR)

(21) Appl. No.: 14/320,646

(22) Filed: Jul. 1, 2014

(30) Foreign Application Priority Data
May 19, 2014 (KR) 10-2014-0059555

(51) Int. Cl. A47J 27/022

(52) U.S. Cl. CPC A47J 27/022

(57) ABSTRACT

Cookware comprises a main body and a heat transferred part. The main body includes a cooking space. The heat transferred part is disposed under the main body. A flame is transferred to the heat transferred part. A plurality of flame transfer grooves are formed in the heat transferred part.

### CROSS-REFERENCE TO RELATED APPLICATION

This application claims priority tinder 35 U.S.C. §119 to Korean Patent Application No. 10-2014-0059555, filed in the Korean Intellectual Property Office on May 19, 2014, the disclosure of which is incorporated by reference herein in its entirety.

### TECHNICAL FIELD

Exemplary embodiments of the inventive concept relate to cookware, and more particularly, to a cooking vessel that have an increased heat transfer area and that may prevent cooked food from quickly cooling down.

### DISCUSSION OF RELATED ART

Cookware or cooking vessels refer to kitchen utensils used for cooking food, such as flying pans, temperature glass pots or other cooking pots, and caldrons.

For cooking, a cooking vessel is placed on a gas stove and is heated by flames from the gas stove. The cooking vessel typically has a flat bottom and thus suffers from, when heated, restricted heat transfer, and when seated on a cold floor quick dissipation of the transferred heat.

### SUMMARY

According to an exemplary embodiment of the present invention, cookware comprises a main body including a cooking space, a heat transferred part disposed under the main body, a flame transferred to the heat transferred part, and a plurality of flame transfer grooves formed in the heat transferred part.

The plurality of flame transfer grooves may be arranged radially with respect to a middle part of the heat transferred part.

Each of the plurality of flame transfer grooves may comprise a flame inward transfer lower part recessed from an upper part of the heat transferred part, the flame transferred to the flame inward transfer lower part in addition to the heat transferred part and a flame additional transfer side wall part connecting the upper part of the heat transferred part with the flame inward transfer lower part, the flame additionally transferred to the flame additional transfer side wall part.

The upper part of the heat transferred part, the flame inward transfer lower part, and the flame additional transfer side wall part each may have a flat surface.

The upper part of the heat transferred part and the flame inward transfer lower part have flat surfaces parallel with each other, and the flame additional transfer side wall part may have an inclined surface.

The flame inward transfer lower part may be greater in area than the upper part of the heat transferred part.

The upper part of the heat transferred part and the flame inward transfer lower part each may have a flat surface, and the flame additional transfer side wall part has a curved surface.

The flame inward transfer lower part may be greater in area than the upper part of the heat transferred part.

At least one of the upper part of the heat transferred part, the flame inward transfer lower part, or the flame additional transfer side wall part may include a square-wave-shaped part.

The upper part of the heat transferred part may have a curved surface to allow a middle part thereof to be in line contact with a supporting surface.

The upper part of the heat transferred part, the flame inward transfer lower part, and the flame additional transfer side wall part each may have a continuous waveform shape.

According to an exemplary embodiment of the present invention, a cooking vessel comprises a body having a space therein, the body having a width increasing upward and a plurality of protrusions radially arranged under a bottom portion of the body so that two adjacent ones of the plurality of protrusions are spaced apart from each other at a predetermined distance, the plurality of protrusions extending outwardly from a middle part of the bottom portion of the body. A width of each of the plurality of protrusions increases outwardly from the middle part of the bottom portion.

The plurality of protrusions may have different areas from each other.

The plurality of protrusions may have substantially the same area.

A first protrusion of the plurality of protrusions may have substantially the same area as a depressed surface of the bottom portion adjacent to the first protrusion.

A first protrusion of the plurality of protrusions may have a different area from an area of a depressed surface of the bottom portion adjacent to the first protrusion.

A portion between two adjacent protrusions of the plurality of protrusions may have an uneven width, distribution.

The depressed surface or an upper surface of each of the plurality of protrusions may have an uneven surface.

The depressed surface or an upper surface of each of the plurality of protrusions may have an uneven surface.

Each of the plurality of protrusions may be shaped as a fan.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a perspective view illustrating a cooking vessel according to an exemplary embodiment of the inventive concept;

FIG. 2 is a rear view of the cooking vessel shown in FIG. 1, according to an exemplary embodiment of the inventive concept;

FIG. 3 is a side view of the cooking vessel shown in FIG. 1, according to an exemplary embodiment of the inventive concept;

FIG. 4 is an enlarged view of a heat transferred part of the cooking vessel shown in FIG. 3, according to an exemplary embodiment of the inventive concept;

FIG. 5 is a partially enlarged view of a cooking vessel that is put on a table, according to an exemplary embodiment of the inventive concept;

FIG. 6 is a side view illustrating a cooking vessel according to an exemplary embodiment of the inventive concept;

FIG. 7 is an enlarged view of a main part of the cooking vessel shown in FIG. 6, according to an exemplary embodiment of the inventive concept;

FIG. 8 is a side view illustrating a cooking vessel according to an embodiment of the inventive concept;

FIG. 9 is an enlarged view of a main part of the cooking vessel shown in FIG. 8, according to an exemplary embodiment of the inventive concept;

FIG. 10 is a side view illustrating a cooking vessel according to an exemplary embodiment of the inventive concept;

FIG. 11 is an enlarged view of a main part of the cooking vessel shown in FIG. 10, according to an exemplary embodiment of the inventive concept;

FIG. 12 is a side view illustrating a cooking vessel according to an exemplary embodiment of the inventive concept;

FIG. 13 is an enlarged view of a main part of the cooking vessel shown in FIG. 12, according to an exemplary embodiment of the inventive concept;

FIG. 14 is a side view illustrating a cooking vessel according to an exemplary embodiment of the inventive concept; and

FIG. 15 is an enlarged view of a main part of the cooking vessel shown in FIG. 14, according to an exemplary embodiment of the inventive concept;

### DETAILED DESCRIPTION OF EXEMPLARY EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. The same reference denotations may be used to refer to the same or substantially the same elements throughout the specification and the drawings.

As used herein, the singular forms “a,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

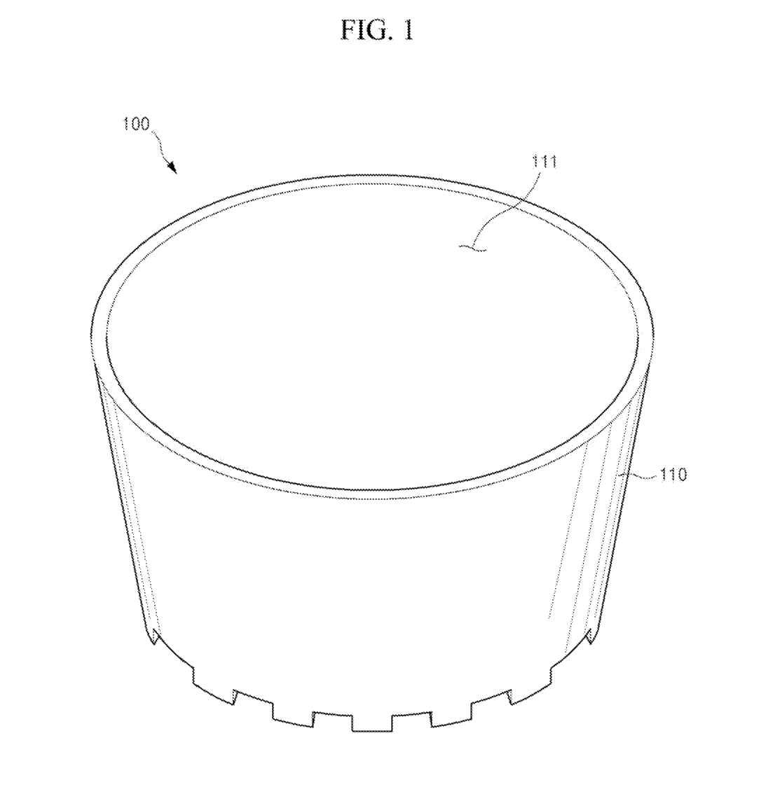

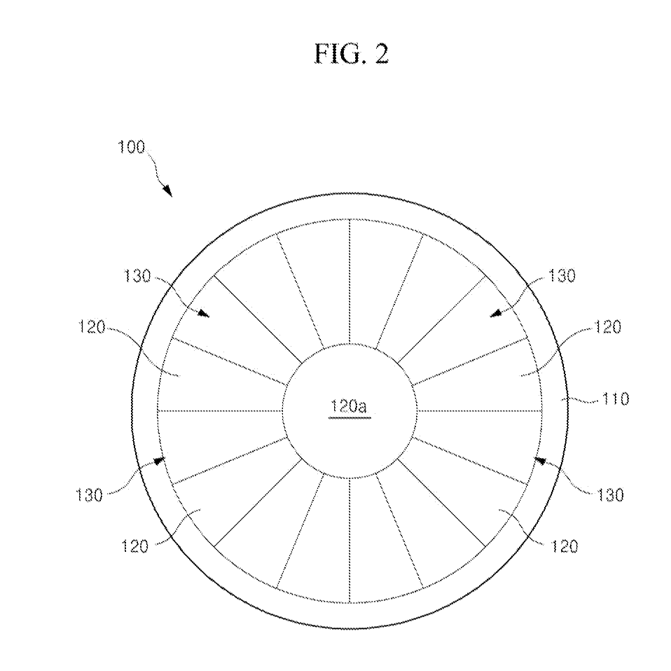

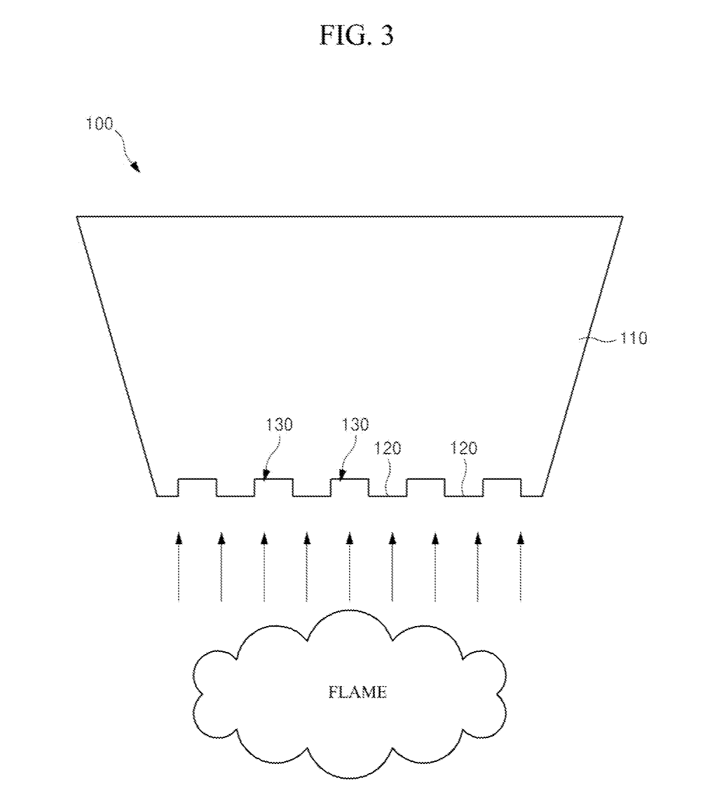

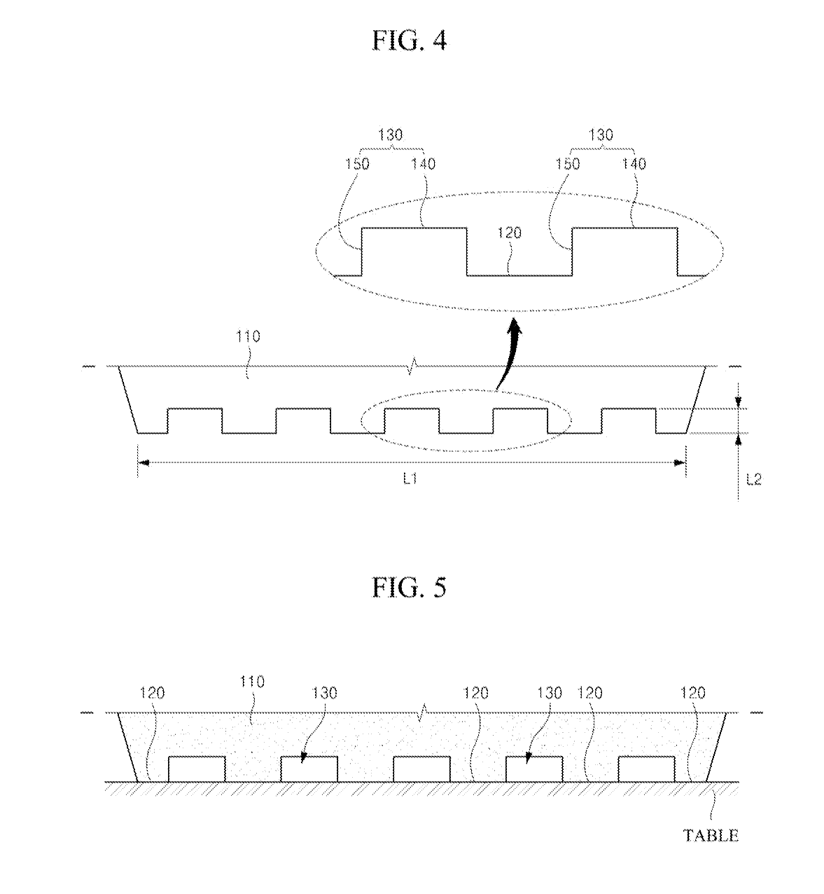

FIG. 1 is a perspective view illustrating a cooking vessel according to an exemplary embodiment of the inventive concept. FIG. 2 is a rear view of the cooking vessel shown in FIG. 1, according to an exemplary embodiment of the inventive concept. FIG. 3 is a side view of the cooking vessel shown in FIG. 1, according to an exemplary embodiment of the inventive concept. FIG. 4 is an enlarged view of a heat transferred part of the cooking vessel shown in FIG. 3, according to an exemplary embodiment of the inventive concept. FIG. 5 is a partially enlarged view of a cooking vessel that is put on a table, according to an exemplary embodiment of the inventive concept.

Referring to FIGS. 1 to 5, according to an exemplary embodiment of the inventive concept, a cooking vessel 100 mainly includes a main body 110 and a heat transferred part 120 to increase heat transfer from a flame on a gas stove and to prevent cooked food from quickly cooling down.

In an exemplary embodiment of the inventive concept, the cooking vessel 100 may include, but is not limited to, a frying pan, a pot, a caldron, and other kitchen utensils for cooking food, such as e.g., boiling, frying, or roasting food.

The main body 110 of the cooking vessel 100 has a cooking space 111 therein. Food is contained in the cooking space 111 and is cooked.

The main body 110 may be formed of, e.g., a metal or reinforced glass that is resistant to heat generated from a gas stove upon cooking.

According to an exemplary embodiment of the inventive concept, the main body 110 has a truncated cone shape in which a cross-sectional area increases upwardly. However, the main body 110 may include, but is not limited to, a circular cylinder shape and various polygonal shapes.

The heat transferred part 120 may include a lower part of the main body 110. The heat transferred part 120 includes a surface to which heat from a flame is transferred. Conventional cookware (not shown) has an overall flat bottom. However, according to an exemplary embodiment of the inventive concept, the bottom of the cooking vessel 100 may be different in shape from the bottom of the conventional cookware.

For example, according to an exemplary embodiment of the inventive concept, the heat transferred part 120 of the cooking vessel 100 includes a plurality of flame transfer grooves 130 that are recessed from an upper part of the heat transferred part 120. The plurality of flame transfer grooves may increase an area through which heat is transferred from a flame to the cooking vessel 100 (the area is also referred to as “heat transfer area”).

For example, the flame transfer grooves 130 may be arranged radially with respect to a center of the heat transferred part 120.

According to an exemplary embodiment of the inventive concept, a middle portion 120a of the heat transferred part 120 may include a flat surface with no groove. The middle portion 120a may be substantially coplanar with the inner bottom of the flame transfer grooves 130.

Each flame transfer groove 130 may be shaped as a fan. The flame transfer grooves 130 each include a flame inward transfer lower part 140 that is recessed from an upper part of the heat transferred part 120 and a flame additional transfer side wall part 150 that connects the upper part of the heat transferred part 120 with the flame inward transfer lower part 140. A flame (or heat from the flame) may be transferred to all of the flame inward transfer lower part 140, the upper part of the heat transferred part 120, and the flame additional transfer side wall part 150.

According to an exemplary embodiment of the inventive concept, the upper part of the heat transferred part 120, the flame inward transfer lower part 140, and the flame additional transfer side wall part 150 each have a flat surface.

For example, the upper part of the heat transferred part 120, the flame inward transfer lower part 140, and the flame additional transfer side wall part 150 may be shaped as substantially a linear square wave when viewed from a side of the cooking vessel 100. According to an exemplary embodiment of the inventive concept, the upper part of the heat transferred part 120 may have substantially the same area as the flame inward transfer lower part 140. Alternatively, the heat transferred part 120 may differ in area from the flame inward transfer lower part 140.

According to an exemplary embodiment of the inventive concept, when the heat transferred part 120 includes the plurality of flame transfer grooves 130 that are recessed from the upper part of the heat transferred part 120, a flame transfer area may be increased. For example, a flame may be transferred to the flame transfer grooves 130 as well as the heat transferred part 120. In other words, the flame may be transferred to the flame inward transfer lower parts 140 and the flame additional transfer side wall parts 150, thus leading to an increased heat transfer from the flame to the cooking vessel 100.

Referring to FIG. 4, areas L2 of the flame additional transfer side wall parts 150 are added to an area L1 of the heat transferred part 120, thus increasing the overall flame transfer area. Accordingly, the heat transfer from the flame to the cooking vessel 100 may be increased.

When the cooking vessel 100 is placed on a cold floor or table after cooking is done, the upper part of the heat transferred part 120 of the cooking vessel 100 is brought in contact with the floor or table, with the flame inward transfer lower parts 140 and the flame additional transfer side wall parts 150 not contacting the floor or table. The flame inward transfer lower parts 140 and the flame additional transfer side wall parts 150 may remain in contact with external heat (e.g., heat from air). Thus, the cooked food in the cooking vessel 100 may be prevented from quickly cooling down.

Accordingly, the cooking vessel 100 with the structure shown in FIGS. 1 to 5 may increase heat transfer from flames to the food and retain the transferred heat for a long time, thus reducing cooking time and keeping the cooked food warm.

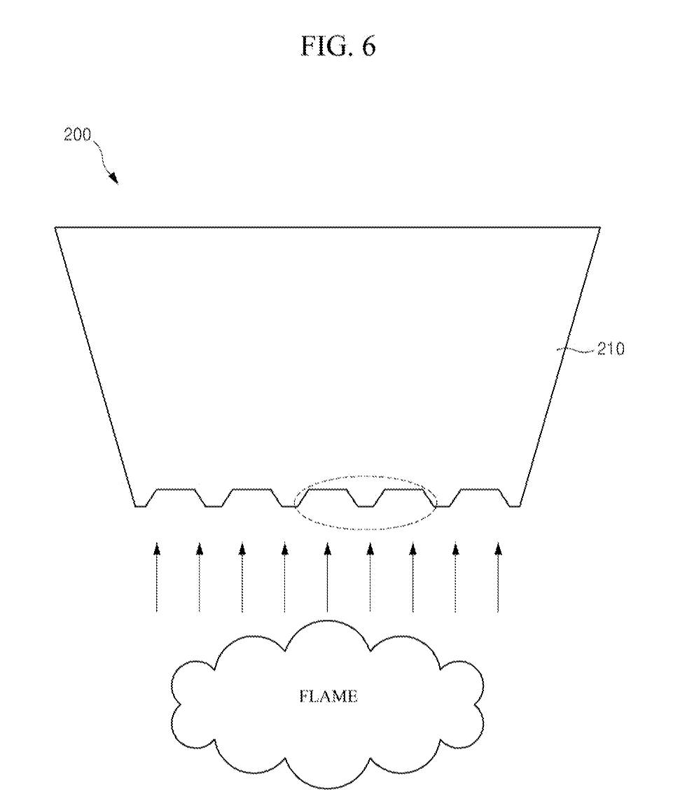

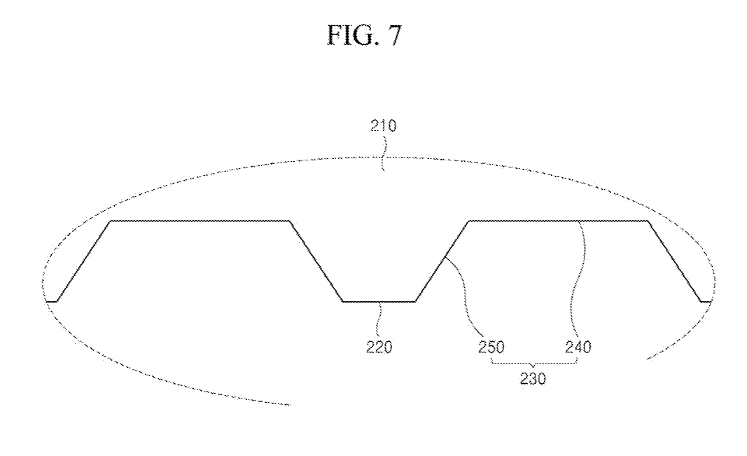

FIG. 6 is a side view illustrating a cooking vessel according to an exemplary embodiment of the inventive concept, and FIG. 7 is an enlarged view of a main part illustrating the cooking vessel shown in FIG. 6, according to an exemplary embodiment of the inventive concept.

Referring to FIGS. 6 and 7, according to an exemplary embodiment of the inventive concept, the cooking vessel 200 includes a main body 210 and a heat transferred part 220.

The heat transferred part 220 includes a plurality of flame transfer grooves 230, each of which includes a flame inward transfer lower part 240 and a flame additional transfer side wall part 250.

In this structure, an upper part of the heat transferred part 220 and the flame inward transfer lower part 240 each have a flat surface, and the flame additional transfer side wall part 250 has an inclined surface, e.g., with respect to the floor. The upper part of the heat transferred part 220 and the flame inward transfer lower part 240 may be parallel with each other.

The flame inward transfer lower part 240 may have an area greater than an area of the upper part of the heat transferred part 220. When the cooking vessel 200 is placed on a table, the upper part of the heat transferred part 220 having a relatively smaller area is brought in contact with the table, thus further preventing the cooked food from quickly cooling down.

According to an exemplary embodiment of the inventive concept, the cooking vessel 200 having the structure shown in FIGS. 6 and 7 may receive more heat from a gas stove flame and may prevent the cooked food from quickly cooling down.

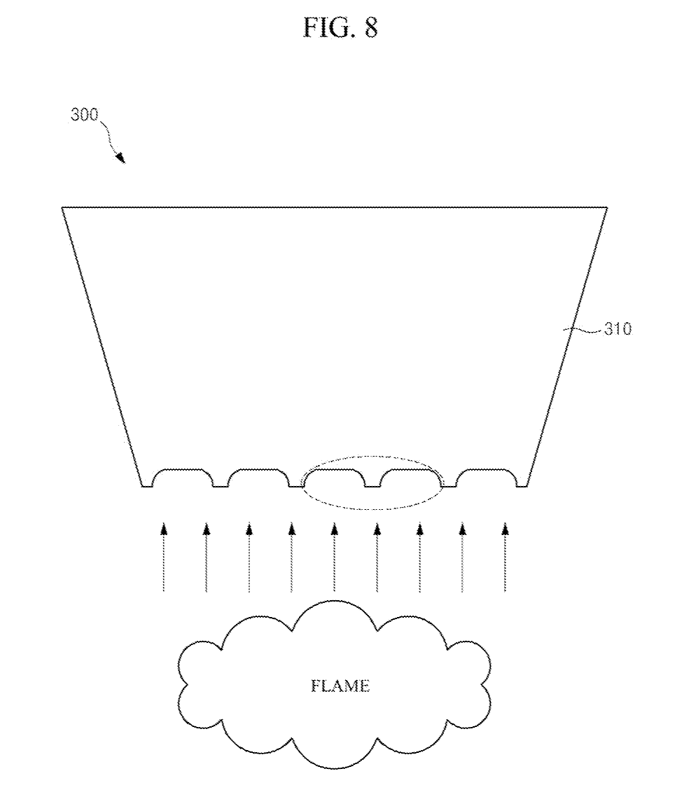

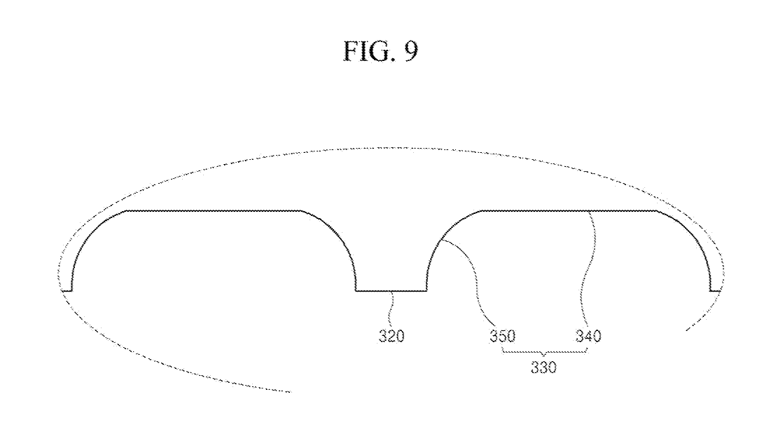

FIG. 8 is a side view illustrating a cooking vessel according to an exemplary embodiment of the inventive concept, and FIG. 9 is an enlarged view of a main part of the cooking vessel shown in FIG. 8, according to an exemplary embodiment of the inventive concept.

Referring to FIGS. 8 and 9, according to an exemplary embodiment of the inventive concept, the cooking vessel 300 includes a main body 310 and a heat transferred part 320.

The heat transferred part 320 includes a plurality of flame transfer grooves 330, each of which includes a flame inward transfer lower part 340 and a flame additional transfer side wall part 350.

In this structure, an upper part of the heat transferred part 320 and the flame inward transfer lower part 340 each have a flat surface, and the flame additional transfer side wall part 350 has a curved surface, e.g., a concave surface.

The concave surface of the flame additional transfer side wall part 350 may guide a flame to the flame inward transfer lower part 340, thus enabling more heat to be transferred from the flame to the cooking vessel 300.

According to an exemplary embodiment of the inventive concept, the area of the flame inward transfer lower parts 340 may be greater than the area of the upper part of the heat transferred part 320. In such case, when the cooking vessel 300 is placed on a table, the upper part of the heat transferred part 320 having relatively a smaller area is brought in contact with on the table with the flame inward transfer lower parts 340 and the flame additional transfer side wall parts 350 not contacting the table, thus preventing the cooked food from quickly cooling down.

According to an exemplary embodiment of the inventive concept, the cooking vessel 300 having the structure shown in FIGS. 8 and 9 may receive more heat from a gas stove flame and may prevent the cooked food from quickly cooling down.

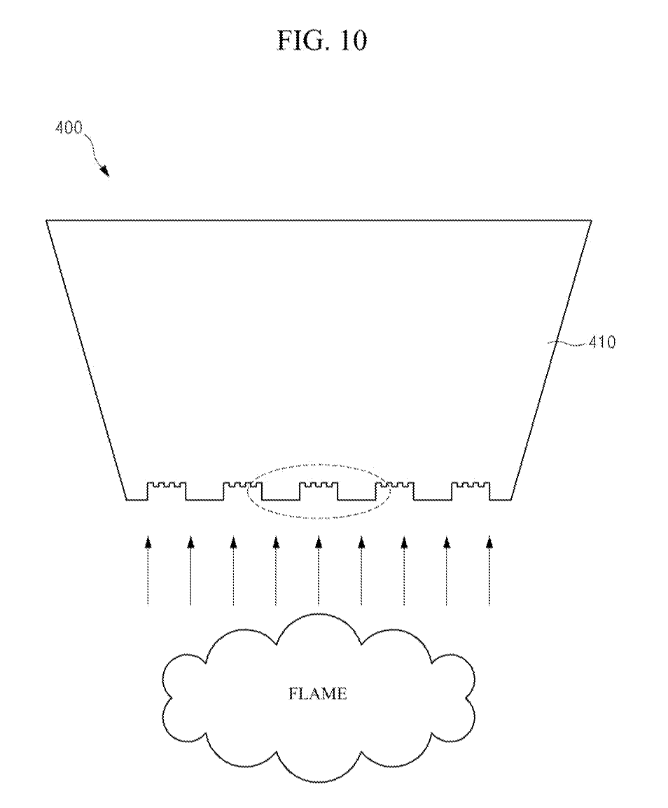

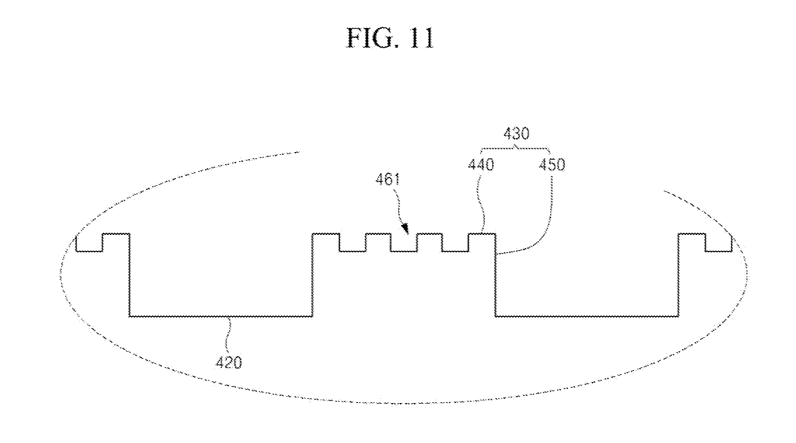

FIG. 10 is a side view illustrating a cooking vessel according to an exemplary embodiment of the inventive concept, and FIG. 11 is an enlarged view of a main part of the cooking vessel shown in FIG. 10, according to an exemplary embodiment of the inventive concept.

Referring to FIGS. 10 and 11, according to an exemplary embodiment of the inventive concept, the cooking vessel 400 includes a main body 410 and a heat transferred part 420.

The heat transferred part 420 includes a plurality of flame transfer grooves 430, each of which includes a flame inward transfer lower part 440 and a flame additional transfer side wall part 450.

In this structure, a small-square-wave-shaped part 461 is further formed in the flame inward transfer lower part 440 of the flame transfer groove 430. In other words, the flame inward transfer lower part 440 of the flame transfer groove 430 may have protrusions and depressions.

According to an exemplary embodiment of the inventive concept, the small-square-wave-shaped part 461 formed in the flame inward transfer lower part 440 of the flame transfer groove 430 may further increase a flame contact area.

According to an exemplary embodiment of the inventive concept, the cooking vessel 400 having the structure shown in FIGS. 10 and 11 may receive more heat from a gas stove flame and may prevent the cooked food from quickly cooling down.

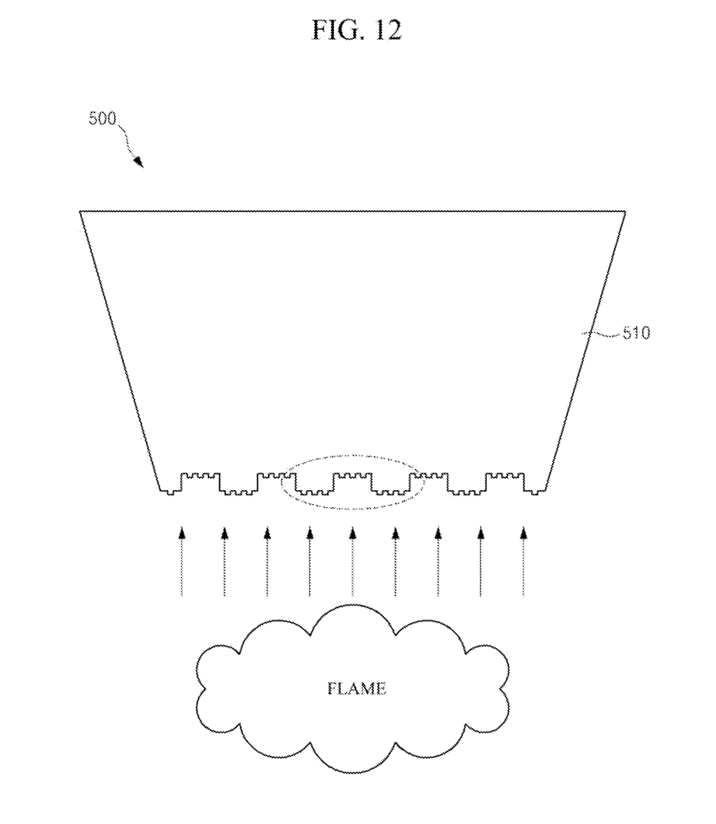

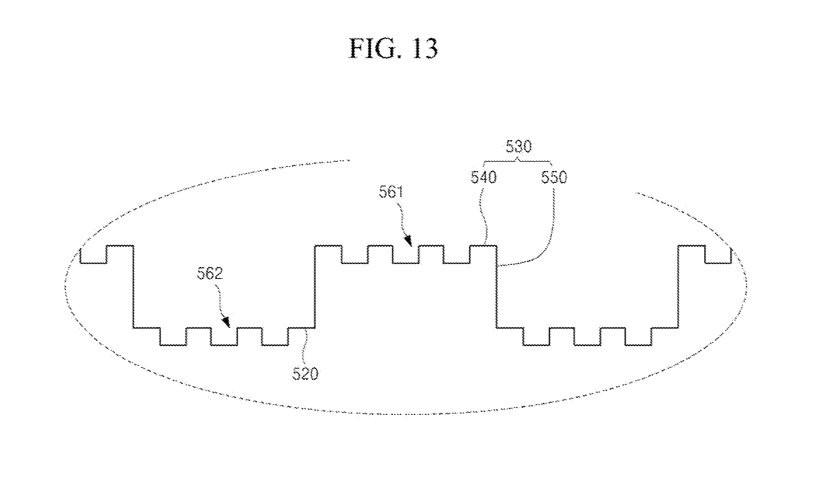

FIG. 12 is a side view illustrating a cooking vessel according to an exemplary embodiment of the inventive concept, and FIG. 13 is an enlarged view of a main part of the cooking vessel shown in FIG. 12, according to an exemplary embodiment of the inventive concept.

Referring to FIGS. 12 and 13, according to an exemplary embodiment of the inventive concept, the cooking vessel 500 includes a main body 510 and a heat transferred part 520.

The heat transferred part 520 includes a plurality of flame transfer grooves 530, each of which includes a flame inward transfer lower part 540 and a flame additional transfer side wall part 550.

In this structure, small-square-wave-shaped parts 561 and 562, respectively, are formed in an upper part of the heat transferred part 520 and the flame inward transfer lower part 540 of the flame transfer groove 530. Alternatively, a small-square-wave-shaped part (not shown) may be formed in the flame additional transfer side wall part 550.

According to an exemplary embodiment of the inventive concept, the small-square-wave-shaped parts 561 and 562 formed in the heat transferred part 520 and the flame inward transfer lower part 540 of the flame transfer groove 530 may increase a flame contact area.

According to an exemplary embodiment of the inventive concept, the cooking vessel 500 having the structure shown in FIGS. 12 and 13 may receive more heat from a gas stove flame and that may prevent the cooked food from quickly cooling down.

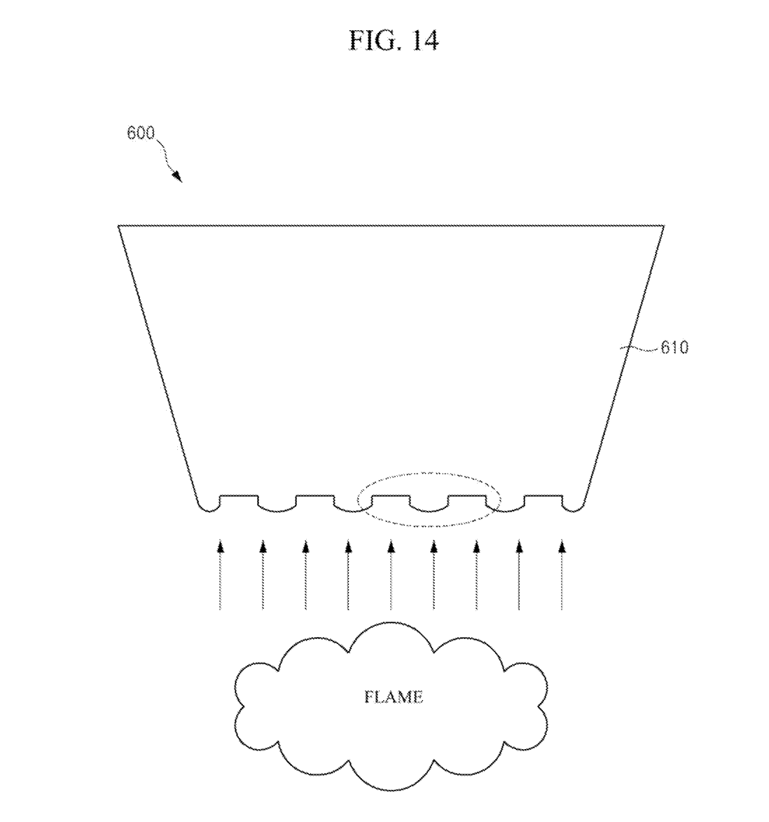

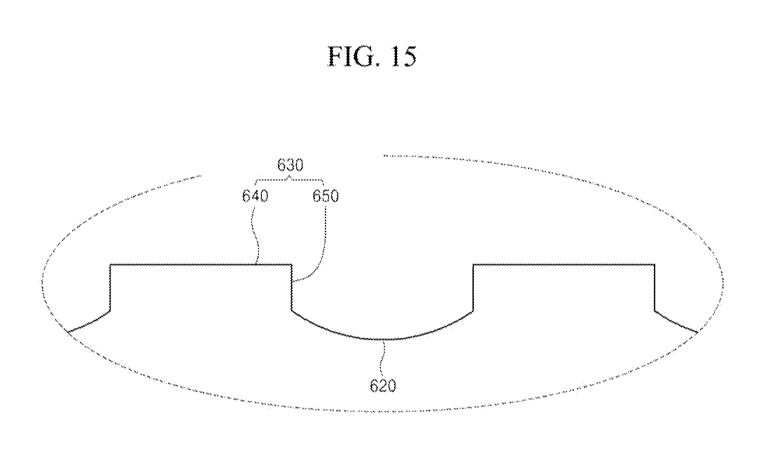

FIG. 14 is a side view illustrating a cooking vessel according to an exemplary embodiment of the inventive concept, and FIG. 15 is an enlarged view of a main part of the cooking vessel shown in FIG. 14, according to an exemplary embodiment of the inventive concept.

Referring to FIGS. 14 and 15, according to an exemplary embodiment of the inventive concept, the cooking vessel 600 includes a main body 610 and a heat transferred part 620.

The heat transferred part 620 includes a plurality of flame transfer grooves 630, each of which includes a flame inward transfer lower part 640 and a flame additional transfer side wall part 650.

In this structure, an upper part of the heat transferred part 620 has a convex surface such that a middle portion of the convex surface is in line contact with a supporting surface of, e.g., a table. Accordingly, a portion of the heat transferred part 620 is in contact with a table, thus efficiently preventing the cooked food from quickly cooling down.

According to an exemplary embodiment of the inventive concept, the cooking vessel 600 having the structure shown in FIGS. 14 and 15 may receive more heat from a gas stove flame and may prevent the cooked food from quickly cooling down.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

1. Cookware, comprising:
a main body including a cooking space;
a heat transferred part disposed under the main body; and
a plurality of flame transfer grooves formed in the heat transferred part, wherein the plurality of flame transfer grooves are arranged radially with respect to a middle part of the heat transferred part, and wherein each of the plurality of flame transfer grooves is shaped as a fan with substantially straight side edges facing each other, an area of the fan increasing away from the middle part of the heat transferred part.

2. (canceled)

3. The cookware of claim 1, wherein each of the plurality of flame transfer grooves comprises:
a flame inward transfer lower part recessed from an upper part of the heat transferred part, the flame transferred to the flame inward transfer lower part in addition to the heat transferred part; and
a flame additional transfer side wall part connecting the upper part of the heat transferred part with the flame inward transfer lower part, the flame additionally transferred to the flame additional transfer side wall part.

4. The cookware of claim 3, wherein the upper part of the heat transferred part, the flame inward transfer lower part, and the flame additional transfer side wall part each have a flat surface.

5. The cookware of claim 3, wherein the upper part of the heat transferred part and the flame inward transfer lower part have flat surfaces parallel with each other, and the flame additional transfer side wall part has an inclined surface.

6. The cookware of claim 5, wherein the flame inward transfer lower part is greater in area than the upper part of the heat transferred part.

7. The cookware of claim 3, wherein the upper part of the heat transferred part and the flame inward transfer lower part each have a flat surface, and the flame additional transfer side wall part has a curved surface.

8. The cookware of claim 6, wherein the flame inward transfer lower part is greater in area than the upper part of the heat transferred part.

9. The cookware of claim 3, wherein at least one of the upper part of the heat transferred part, the flame inward transfer lower part, or the flame additional transfer side wall part includes a square-wave-shaped part.

10. The cookware of claim 1, wherein the upper part of the heat transferred part has a curved surface to allow a middle part thereof to be in line contact with a supporting surface.

11. The cookware of claim 3, wherein the upper part of the heat transferred part, the flame inward transfer lower part, and the flame additional transfer side wall part each have a continuous waveform shape.

12. A cooking vessel, comprising:
a body having a space therein, the body having a width increasing upward; and
a plurality of protrusions radially arranged under a bottom portion of the body so that two adjacent ones of the plurality of protrusions are spaced apart from each other at a predetermined distance, the plurality of protrusions extending outwardly from a middle part of the bottom portion of the body, wherein a width of each of the plurality of protrusions increases outwardly from the middle part of the bottom portion, and wherein each of the plurality of protrusions is shaped as a fan with substantially straight side edges facing each other, an area of the fan increasing away from the middle part of the bottom portion of the body.

13. The cooking vessel of claim 12, wherein the plurality of protrusions have different areas from each other.

14. The cooking vessel of claim 12, wherein the plurality of protrusions have substantially the same area.

15. The cooking vessel of claim 12, wherein a first protrusion of the plurality of protrusions has substantially the same area as a depressed surface of the bottom portion adjacent to the first protrusion.

16. The cooking vessel of claim 12, wherein a first protrusion of the plurality of protrusions has a different area from an area of a depressed surface of the bottom portion adjacent to the first protrusion.

17. The cooking vessel of claim 12, wherein a portion between two adjacent protrusions of the plurality of protrusions has an uneven width distribution.

18. The cooking vessel of claim 15, wherein the depressed surface or an upper surface of each of the plurality of protrusions has an uneven surface.

19. The cooking vessel of claim 16, wherein the depressed surface or an upper surface of each of the plurality of protrusions has an uneven surface.

20. (canceled)
